(19) United States
(12) Patent Application Publication
(10) Pub. No.: US 2018/0291879 A1
(43) Pub. Date: Oct. 11, 2018

(54) ELECTRICAL GENERATOR HAVING REDUCED BEARING CURRENTS

(71) Applicant: Siemens Wind Power A/S, Brande (DK)

(72) Inventor: Klaus Wadsholt, Fredericia (DK)

(21) Appl. No.: 15/946,795

(22) Filed: Apr. 6, 2018

(30) Foreign Application Priority Data
Apr. 11, 2017 (DE) 102017206216.9

(51) Int. Cl. F03D 80/70; F03D 13/20; H02K 7/18; F03D 7/02; H02K 7/08; F03D 3/06

(52) U.S. Cl. CPC F03D 80/70; F03D 13/20; H02K 7/183; F03D 7/0272; F16C 2360/31; F03D 3/062; F05B 2240/21; F05B 2250/00; H02K 7/08

(57) ABSTRACT

An electrical generator including a stator having a frame body and a plurality of slots in the frame body for housing a winding, a rotor arranged to be rotatable relative to the stator, the slots having at least a first portion radially facing the stator and a second portion adjacent to the first portion, the winding being housed in the second portion of the slot. The first portion and the second portion are geometrically configured with respect to each other in such a way that at least a portion of the frame is radially interposed between the winding and the rotor.

### CROSS-REFERENCE TO RELATED APPLICATIONS

This application claims priority to German application No. 102017206216.9 having a filing date of Apr. 11, 2017, the entire contents of which are hereby incorporated by reference.

### FIELD OF INVENTION

The following relates to an electric generator for reducing an electric current flowing between a rotor and a stator of the electrical generator via one or more bearings. Such electric current is normally called “bearing current”. Furthermore, embodiments of the invention relates to a method to reduce the bearing current in an electric generator.

### ART BACKGROUND

An electrical generator, such as an electric generator installed in a wind turbine, typically comprises a rotor which rotates relative to a stator. The rotor and the stator are connected to each other via bearings, such as e.g. a roller bearing, a tapered bearing, a hydrostatic bearing or a hydrodynamic bearing.

A voltage may occur over the bearing, e.g. due to capacitive coupling of a common mode voltage of an inverter from a winding to the rotor. However, the bearing currents resulting from such a voltage may jeopardize the lifetime of the bearing and may in some situations cause immediate damage to the bearing. This may lead to a bearing failure and to a decreased life span of the electrical machine.

It cannot completely be avoided the occurrence of bearing currents. In addition, the bearings are primarily designed to carry or support an electric current.

Therefore, there is still a need to provide an improved way to reduce the common mode electric current flowing between a rotor and a stator of an electrical machine via the bearings.

### SUMMARY

According to a first aspect of embodiments of the invention, it is provided an electric generator comprising:
a stator having a frame body and a plurality of slots in the frame for housing a winding,
a rotor arranged to be rotatable relative to the stator, the slots having at least a first portion radially facing the rotor and a second portion adjacent to the first portion, the winding being housed in the second portion of the slot,
   wherein the first portion and the second portion are geometrically configured with respect to each other in such a way that at least a portion of the frame is radially interposed between the winding and the rotor.

The above described electric generator may be advantageously integrated in a wind turbine.

According to a second aspect of embodiments of the invention, it is provided a method of manufacturing an electrical generator comprising:
a stator having a frame body and a plurality of slots in the frame for housing a winding, a plurality of teeth being circumferentially alternated between the plurality of slots,
a rotor arranged to be rotatable relative to the stator, the slots having at least a first portion radially facing the rotor and a second portion adjacent to the first portion, the winding being housed in the second portion of the slot,
   wherein the first portion and the second portion are geometrically configured with respect to each other in such a way that at least a portion of the frame is radially interposed between the winding and the rotor and wherein the method include the step of obtaining the teeth by lamination.

Advantageously, the present embodiments of the invention allow reducing the bearing currents by shielding the coupling between stator and rotor. Embodiments of the invention utilize the lamination of the teeth of the stator by shifting the first portion of the stator slot (i.e. the portion of the slot radially directing facing the rotor) where the slot entrance is shifted to the right (or left). By doing so the capacitance from winding to rotor is reduced.

According to an embodiment of the invention, the electric generator the first portion and the second portion are shifted with respect to each other in such a way that at least a portion of the frame is radially interposed between the winding and the rotor. Advantageously, in such a way the winding in the second portion of the slot are not completely radially facing the rotor, as in solutions of the prior art, thus reducing the capacitance from winding to rotor of the electric generator.

The first portion and the second portion may be shifted respect to each other along a direction orthogonal to a rotational axis of the rotor relative to the stator, i.e. clockwise or counter-clockwise.

According to a further embodiment of the invention, the first portion is geometrically configured in order to symmetric with respect to a first radial symmetry plane and the second portion is geometrically configured in order to symmetric with respect to a second radial symmetry plane, the first radial symmetry plane and the second radial symmetry plane being shifted respect to each other along a direction orthogonal to a rotational axis of the rotor relative to the stator.

By simply shifting the two portions of the slots relatively to each other, it is advantageously possible to use the same windings and wedges, which are used in solutions of the prior art.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this document.

The aspects defined above and further aspects of embodiments of the present invention are apparent from the examples of embodiment to be described hereinafter and are explained with reference to the examples of embodiment. Embodiments of the invention will be described in more detail hereinafter with reference to examples of embodiment but to which the invention is not limited.

### BRIEF DESCRIPTION

Some of the embodiments will be described in detail, with reference to the following figures, wherein like designations denote like members, wherein:

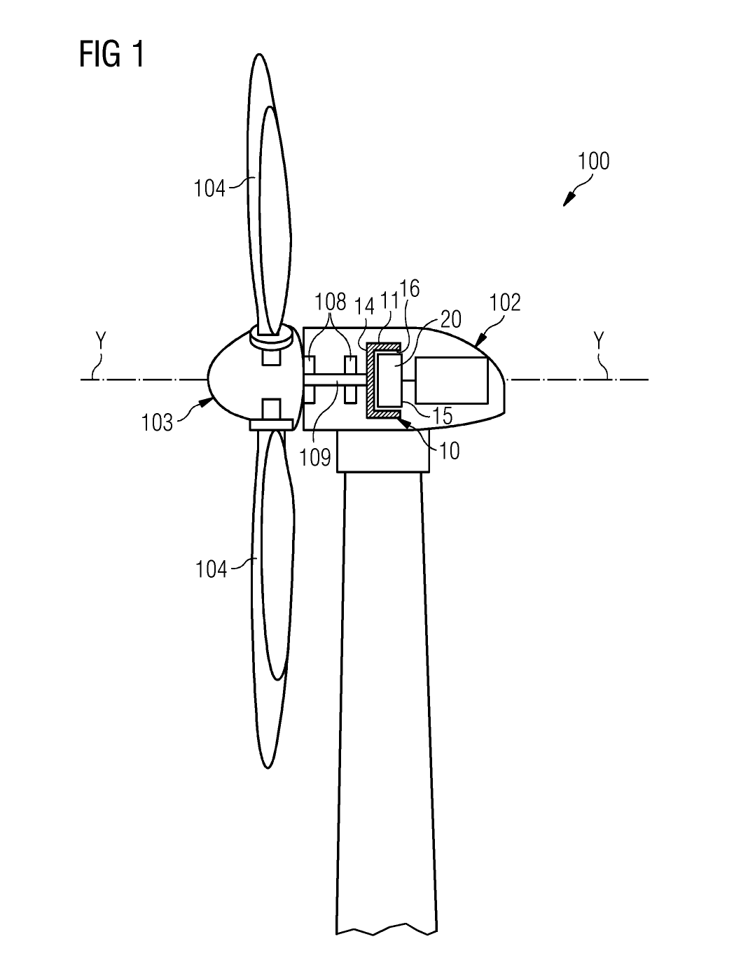

FIG. 1 shows a wind turbine comprising an electric generator in accordance with an embodiment of the invention;

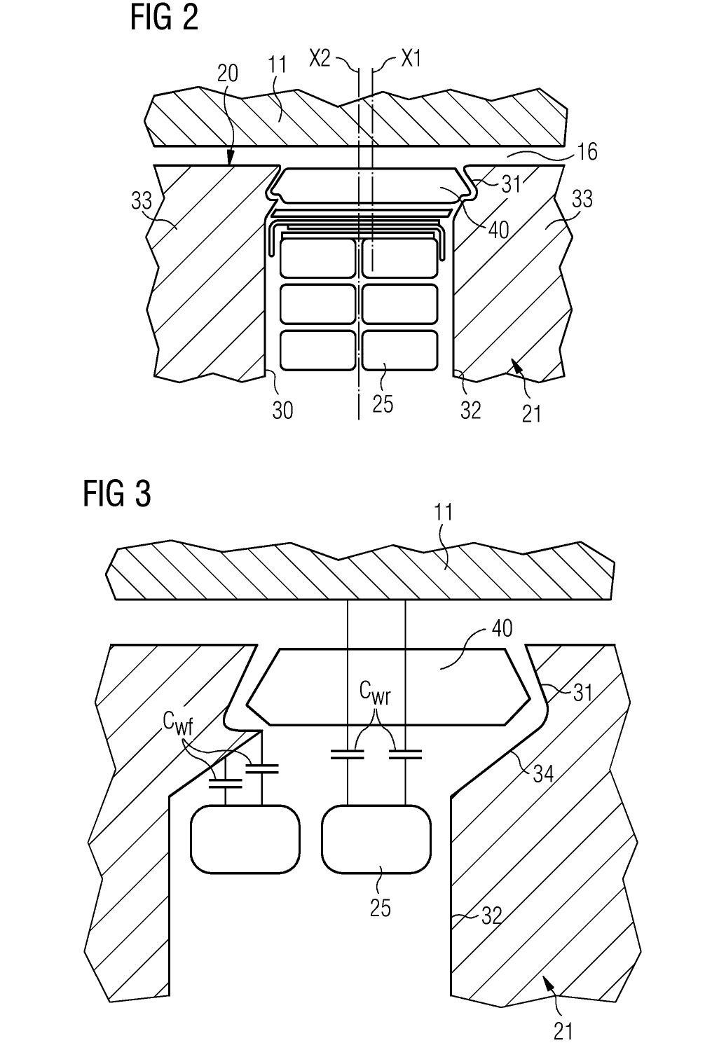

FIG. 2 shows a first schematic partial cross section of an electric generator in accordance with an embodiment of the invention;

FIG. 3 shows a second schematic partial cross section of an electric generator in accordance with the same embodiment of the invention in FIG. 2

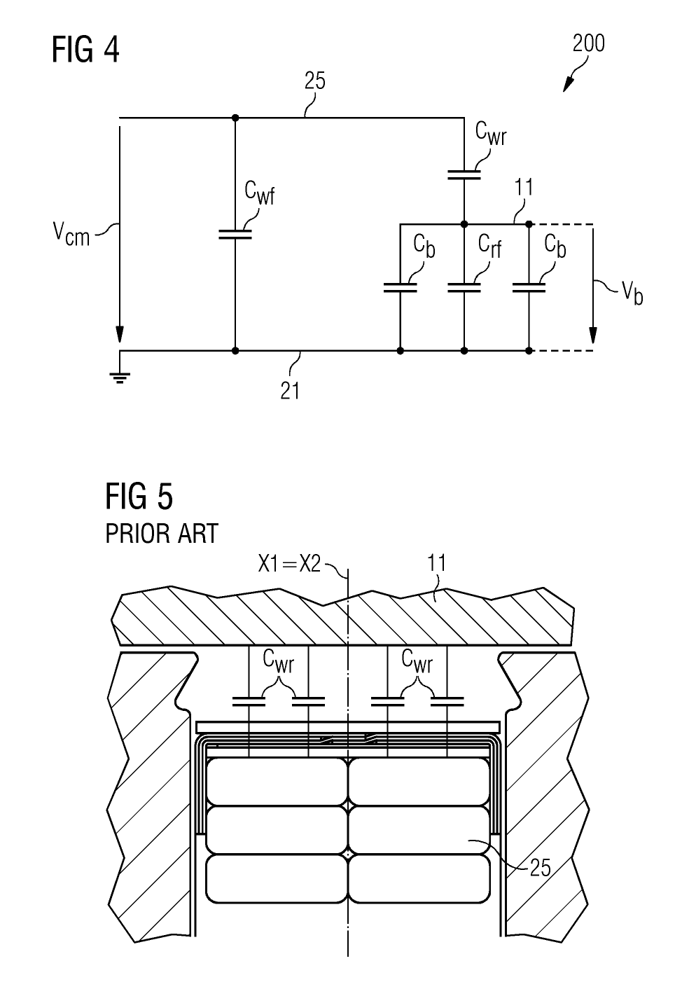

FIG. 4 shows an equivalent electric circuit diagram for an electrical generator in the invention; and

FIG. 5 shows a schematic partial cross section of an electric generator in accordance with the prior art.

### DETAILED DESCRIPTION

The illustrations in the drawings are schematic. It is noted that in different figures, similar or identical elements are provided with the same reference signs.

FIG. 1 shows a wind turbine 100 according to embodiments of the invention. The wind turbine 100 comprises a tower 101, which is mounted on a non-depicted fundament. A nacelle 102 is arranged on top of the tower 101.

The wind turbine 100 further comprises a wind rotor 103 having three blades 104 (in the perspective of FIG. 1 only two blades 104 are visible). The wind rotor 103 is rotatable around a rotational axis Y. When not differently specified, the terms axial, radial and circumferential in the following are made with reference to the rotational axis Y. The blades 104 extend radially with respect to the rotational axis Y.

The wind turbine 100 comprises an electric generator 10, which includes a stator 20 and a rotor 11.

According to other possible embodiment of the present invention, the electric generator 10 not included in a wind turbine.

The wind rotor 103 is rotationally coupled with the rotor 3 by means of a rotatable shaft 109. A schematically depicted bearing assembly 108 is provided in order to hold in place both the wind rotor 103 and the rotor 11. As can be seen from FIG. 1 the rotatable shaft 109 extends along the rotational axis Y.

The electric generator 10 extends along the rotational axis Y between an axial drive end 14 and an axially opposite non-drive end 15. The drive end 14 is connected to the rotatable shaft 109 of the wind turbine 100. The rotational axis Y is also coincident with an axis of rotation of the rotor 11 around the stator 20. Bearings of the bearing assembly 108 may be present at one or both of the axial drive end 14 and of the non-drive end 15.

As shown in FIG. 2 and FIG. 3, the stator 20 comprises a frame body 21 having a plurality of slots 30 (only one slot 30 is shown in the FIGS. 2 and 3) and a plurality of teeth 33 (only two teeth 33 are shown in the FIGS. 2 and 3) being circumferentially alternated between the plurality of slots 30. The teeth 33 and, consequently, the slots 30 between them are manufactured by lamination.

Each slot 30 houses a respective winding 25 and a wedge 40. Each wedge 40 protects and keeps in place the respective winding 25. In order to respectively house the wedge 40 and the winding 25, the slot 30 has a first portion 31 radially facing the rotor 11 and a second portion 32, which is adjacent to the first portion 31 and more remote from the rotor 11 than the first portion 31.

The first portion 31 is geometrically configured in order to be symmetric with respect to a first radial symmetry plane X1 and the second portion 32 is geometrically configured in order to be symmetric with respect to a second radial symmetry plane X2.

The rotor 11 is arranged around the stator 20 and is rotatable relative to the stator 20, around the rotational axis Y.

An air gap 16, which extends circumferential around the axis Y, is provided between the rotor 11 and the stator 20.

According to another embodiment of the present invention (not represented in the attached figures) the stator 20 is arranged around the rotor 11.

FIG. 4 shows an equivalent electric circuit diagram 200 for the electrical generator 10. The stator winding 25, the rotor 11 and the frame body 21 are also schematically indicated. The capacitance between winding 25 and frame body 21 is C_{wf}, the capacitance between winding 25 and rotor 11 is C_{wr} and the capacitance between rotor 11 and frame body 21 is shown as a parallel coupling of C_{rf} and two bearing capacitances C_{b}.

According to another embodiment of the present invention (not represented in the attached figures) only a single bearing may be used and therefore also in the equivalent electric circuit only one bearing capacitance C_{b} is used.

It is therefore assumed that the bearing capacitance C_{b} at the drive end 14 has the same value of the bearing capacitance C_{b} at the non-drive end 15 of the electric generator 10. However, as it will be clearer in the following embodiments of the present invention apply independently from the values and distribution of the bearing capacitances C_{b}.

When a common mode voltage V_{cm} occurs between the winding 110 and the grounded frame 130, the bearing voltage V_{b} is given as:

V_{b}=V_{cm}*C_{wr}(C_{wr}C_{rf}+2*C_{b}).

In the embodiments where only one bearing capacitance C_{b} is used, the bearing voltage V_{b} is given as:

V_{b}=V_{cm}*C_{wr}(C_{wr}+C_{rf}+C_{b}).

From the above expression, it is evident that V_{b} can be reduced by reducing the capacitance C_{wr} between winding 25 and rotor 11.

Embodiments of the present invention achieve this because the first portion 31 and the second portion 32 are geometrically configured with respect to each other in such a way that at least a portion of the frame 21 is radially interposed between the winding 25 and the rotor 11.

As shown in the embodiment of FIG. 2 and FIG. 3, the first portion 31 and the second portion 32 are circumferentially (i.e. orthogonally to the rotational axis Y) shifted with respect to each other in such a way that at least a portion of the frame 21 is radially interposed between the winding 25 and the rotor 11. The first radial symmetry plane X1 and the second radial symmetry plane X2 are also shifted with respect to each other along a circumferentially direction orthogonal to the rotational axis Y.

As a result, an upper part 34 of the second portion 32 directly connected to the first portion 31 is deformed in the same direction of the shifting of the first portion 31 of the slot. Such upper part 34 of the second portion 32 of the slot 33 shields a portion of the winding 25, in such a way that upper part 34 of the second portion 32 is radially interposed between such portion of the winding 25 and the rotor 11. Such portion of the winding 25 is not completely radially facing the rotor 11, as in solutions of the prior art solution shown in FIG. 5, thus reducing the capacitance C_{wr} from winding to rotor of the electric generator 10. At the same time the capacitance C_{wf} between winding 25 and frame body 21 is increased.

The prior art solution in FIG. 5 shows a prior art stator where the first portion for housing the wedge 40 and the second portion for housing the winding 25 are not shifted to each other, the first radial symmetry plane X1 and the second radial symmetry plane X2 being coincident.

The manufacturing of the teeth 33 of the stator 20 by lamination permits achieving the shape of the slots 30 required by embodiments of the present invention in a fast and cost effective way.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An electrical generator comprising:
a stator having a frame body and a plurality of slots in the frame body for housing a winding;
a rotor arranged to be rotatable relative to the stator, the plurality of slots having at least a first portion radially facing the rotor and a second portion adjacent to the first portion, the winding being housed in the second portion of the slot, wherein the first portion and the second portion are geometrically configured with respect to each other in such a way that at least a portion of the frame body is radially interposed between the winding and the rotor.

2. The electric generator as claimed in claim 1, wherein the first portion and the second portion are shifted with respect to each other in such a way that at least a portion of the frame body is radially interposed between the winding and the rotor.

3. The electric generator as claimed in claim 2, wherein the first portion and the second portion are shifted respect to each other along a direction orthogonal to a rotational axis of the rotor relative to the stator.

4. The electric generator as claimed in claim 2, wherein an upper part of the second portion directly connected to the first portion is radially interposed between the winding and the rotor.

5. The electric generator as claimed in claim 3, wherein the first portion is geometrically configured in order to be symmetric with respect to a first radial symmetry plane and the second portion is geometrically configured in order to be symmetric with respect to a second radial symmetry plane, the first radial symmetry plane and the second radial symmetry plane being shifted with respect to each other along a direction orthogonal to a rotational axis of the rotor relative to the stator.

6. The electric generator as claimed in claim 1, wherein a wedge is housed in the second portion of the slot.

7. A wind turbine including an electric generator as claimed in claim 1.

8. A Method of manufacturing an electrical generator comprising, the electrical generator including a stator having a frame body and a plurality of slots in the frame body for housing a winding, a plurality of teeth being circumferentially alternated between the plurality of slots, a rotor arranged to be rotatable relative to the stator, the plurality of slots having at least a first portion radially facing the rotor and a second portion adjacent to the first portion, the winding being housed in the second portion of the slot, wherein the first portion and the second portion are geometrically configured with respect to each other in such a way that at least a portion of the frame is radially interposed between the winding and the rotor, the method comprising:
obtaining the plurality of teeth by lamination.
